(19) United States
(12) Patent Application Publication
(10) Pub. No.: US 2007/0210132 A1
(43) Pub. Date: Sep. 13, 2007

(54) Combustion Type Power Tool Having Sealing Arrangement

(76) Inventor: Yoshitaka Akiba, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/682,962

(22) Filed: Mar. 7, 2007

(30) Foreign Application Priority Data
Mar. 8, 2006 (JP) P2006-062728

(51) Int. Cl. B25C 1/14

(52) U.S. Cl. 227/10

(57) ABSTRACT

A combustion type power tool selectively defining a combustion chamber as a result of movement of a combustion chamber frame. A sealing arrangement is provided at a boundary between an outer peripheral section of a chamber head and an inner peripheral portion of an upper portion of the combustion chamber frame. Another sealing arrangement is provided at a boundary between an inner peripheral portion of a lower portion of the combustion chamber frame and an outer peripheral portion of an upper portion of a cylinder. Annular grooves are formed in the outer peripheral section of the chamber head and the outer peripheral portion of the cylinder. Each sealing arrangement is assembled in the annular groove, and includes an endless O-ring and a back-up ring disposed at an inner peripheral side of the O-ring for urging the O-ring radially outwardly.

### BACKGROUND OF THE INVENTION

The present invention relates to a combustion type power tool, and more particularly, to a type thereof in which liquid gas filled in a gas canister is injected into a combustion chamber, mixed with air and ignited, thereby generating force, which moves a piston to drive fasteners such as nails, rivets and staples.

FIG. 7 is an enlarged view showing a cross-section of a conventional portable combustion type power tool, such as a nail gun 50. The nail gun 50 includes a housing 7, a cylinder 2, a piston 3, a driver blade 16, a chamber head 5 formed with a gas injection port 23, a combustion chamber frame 4, a canister housing 25, a fan 21, an ignition plug 26, and a trigger switch (not shown). The housing 7 accommodates therein various components. The cylinder 2 is fixed in the housing 7. The piston 3 is reciprocally movable relative to the cylinder 2 between the upper end and lower end thereof. The driver blade 16 is fixed to a lower surface 3b of the piston 3 for driving fasteners, such as nails, into a workpiece as the piston 3 moves down in the cylinder 2. The chamber head 5 is spaced from the upper end of the cylinder 2, and is secured in the housing 7. The combustion chamber frame 4 is provided in the housing 7, and is movable move up and down while sliding on an outer circumferential surface of the cylinder 2. The combustion chamber frame 4 forms a combustion chamber 6, together with the chamber head 5, an upper portion of the cylinder 2, and the upper surface 3a of the piston 3. The canister housing 25 is provided in the housing 7 for accommodating a gas canister 22. The gas injection port 23 is adapted for injecting combustible gas from an injection nozzle 22a of the gas canister 22 into the combustion chamber 6. The fan 21 is provided in the combustion chamber 6. The ignition plug 26 is adapted for igniting the mixture of air and the combustible gas injected into the combustion chamber 6 through the gas injection port 23. The trigger switch (not shown) is secured to a handle provided on the housing 7.

A push lever or a contact lever (not shown) protrudes from the lower end of the cylinder 2. When the entire tool is pushed to the workpiece with the push lever being in contact with the workpiece, the push lever is moved upwards. Thus, the combustion chamber frame 4 moves up and abuts on the chamber head 5, defining the combustion chamber 6 sealed from an atmosphere. The junction of the combustion chamber frame 4 and the chamber head 5, which define an upper half of the combustion chamber 6 in FIG. 7, is closed by an O-ring 9 made from rubber. The upper half of the combustion chamber 6 is thereby sealed from the atmosphere. On the other hand, the junction of the combustion chamber frame 4 and the cylinder 2, which define the lower half of the combustion chamber 6, is closed by an O-ring 10 made from a rubber. The lower half of the combustion chamber 6 is thereby sealed from the atmosphere. Thus, the O-rings 9 and 10 close the combustion chamber 6.

The combustible gas is then injected into the combustion chamber 6 from the injection nozzle 22a of the gas canister 22. In the combustion chamber 6, the fan 21 stirs the combustible gas and mixes the gas with air, generating mixture gas. An ignition control device (not shown) permit the ignition plug 26 to generate a spark in the combustion chamber 6. The mixture gas is thereby combusted, generating a force that drives a fastener into the workpiece.

The combustion type power tool 50 need not have a compressor, unlike conventional pneumatically operated fastener driver. The power tool 50 can therefore be transported to a construction site more easily than the conventional fastener driver. In addition, since the power tool 50 has a built-in power supply such as a secondary battery, the power tool 50 requires no other power supplies including the commercially available power supply. Therefore, the power tool 50 is portable and improves operability. A combustion type power tool of this type is disclosed in U.S. Pat. No. 5,197,646.

In the conventional combustion type power tool described above, an upper-end seal part 4a (see circle A shown in FIG. 7) and a lower-end seal part 4b (see circle B shown in FIG. 7) perform sealing function for the combustion chamber 6 from the atmosphere when the piston 3 lies at the top dead center. This sealing fashion results in the following two advantages.

### (1) Since the combustion chamber 6 is sealed from the atmosphere, the piston 3 can effectively be driven by expansion energy generated as the gas is combusted, to thus efficiently drive fasteners into the workpiece.

(2) Since the combustion chamber 6 is sealed from the atmosphere, a negative pressure can be generated in the combustion chamber 6 as heat is released from the components of the combustion chamber 6, lowering the temperature in the combustion chamber 6. The piston can therefore be returned from the bottom dead center to the initial top dead center position because of the pressure differential.

In the conventional combustion type power tool, further improvement on sealability is required in the seal rings 10 and 9 in order to enhance explosion power and to assure complete return of the piston for the subsequent operation.

### SUMMARY OF THE INVENTION

It is therefore an object of the present invention is to provide a combustion type power tool capable of improving sealing effect in the gap between the combustion chamber frame and the cylinder and/or the gap between the combustion chamber frame and the chamber head.

Another object of the invention is to provide such a combustion type power tool capable of providing a higher impacting force to a fastener with a driver blade.

These and other objects of the present invention will be attained by a combustion type power tool including a housing, a chamber head, a cylinder, a combustion chamber frame, and at least one sealing unit. The chamber head is fixed to one end of the housing. The cylinder is fixedly disposed in the housing. The combustion chamber frame is movable toward and away from the chamber head within the housing. A combustion chamber is defined when the combustion chamber frame is in abutment with the chamber head. At least one of the chamber head and the cylinder is formed with an annular groove. The at least one sealing unit is assembled in the annular groove and includes a sealing member, and a back-up ring disposed in contact with the sealing member. The back-up ring provides a radially outward expansion force for urging the sealing member radially outwardly.

### BRIEF DESCRIPTION OF THE DRAWINGS

In the drawings:

FIG. 1 is a cross-sectional view of a combustion type power tool according to an embodiment of the present invention, and particularly showing an initial state of the combustion type power tool;

FIG. 2 is a cross-sectional view of the combustion type power tool according to the embodiment, and particularly showing a piston staying at the top dead center;

FIG. 3 is a cross-sectional view of an essential portion of the combustion type power tool according to the embodiment, and particularly showing the piston staying at the bottom dead center;

FIG. 4 is an enlarged cross-sectional view illustrating a seal unit provided between a cylinder and a combustion chamber frame, both shown in FIG. 1;

FIG. 5 is an enlarged cross-sectional view illustrating another seal unit provided between a chamber head and the combustion chamber frame, both shown in FIG. 1;

FIG. 6 is a perspective view of a C-ring used in the seal unit shown in FIGS. 4 and 5;

FIG. 7 is a cross-sectional view showing a part of a conventional combustion type power tool;

FIG. 8 is an enlarged cross-sectional view illustrating a seal unit in accordance with a related art and to be provided between a cylinder and a combustion chamber frame in the conventional combustion type power tool shown in FIG. 7;

FIG. 9 is an enlarged cross-sectional view illustrating the seal unit at a time when a piston is moved toward its top dead center from its bottom dead center in accordance with the related art and to be provided between the cylinder and the combustion chamber frame, in the conventional combustion type power tool shown in FIG. 7;

FIG. 10 is a cross-sectional view illustrating the seal unit, taken long line X-X in FIG. 9;

FIG. 11 is an enlarged cross-sectional view illustrating another seal unit in accordance with a related art and to be provided between a chamber head and the combustion chamber frame in the conventional combustion type power tool shown in FIG. 7;

FIG. 12 is an enlarged cross-sectional view showing still another seal unit in accordance with a related art and including iron rings provided between a cylinder and a combustion chamber frame; and

FIG. 13 is a perspective view showing one of the iron rings shown in FIG. 12.

### DETAILED DESCRIPTION OF THE PREFERRED EMBODIMENTS

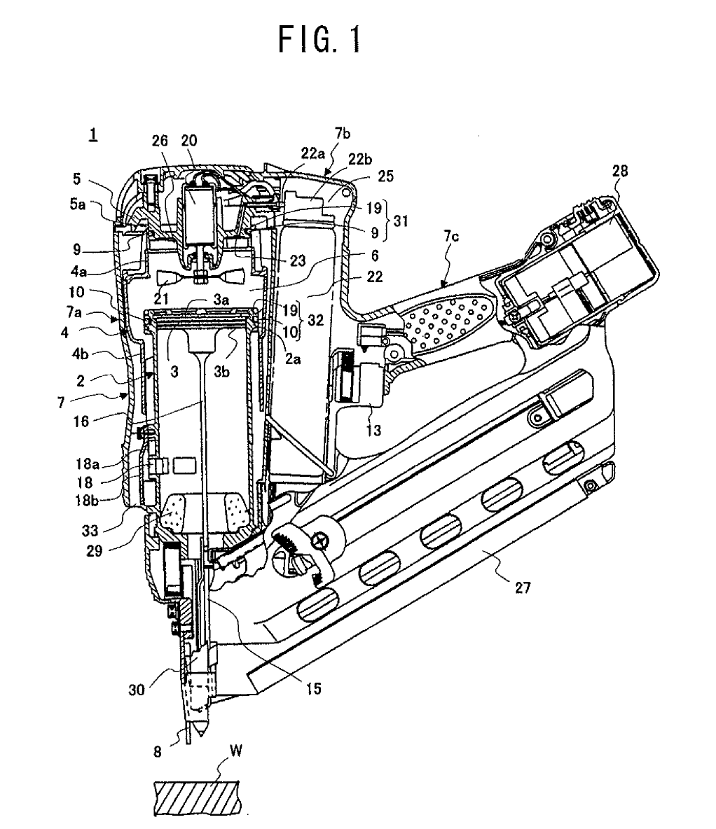

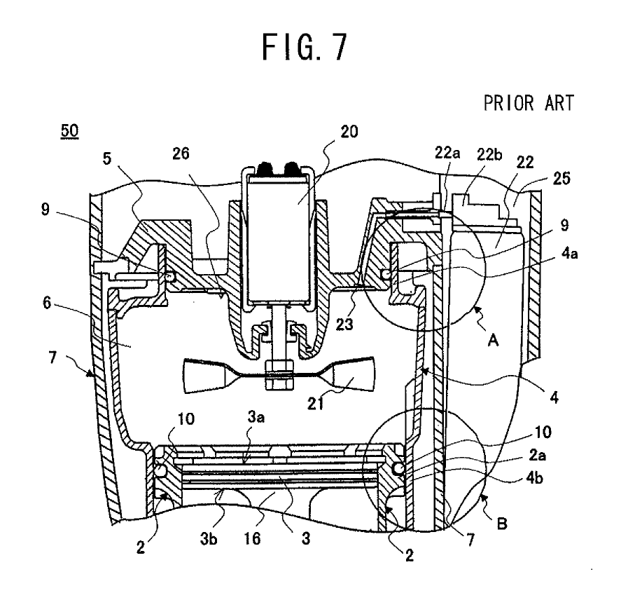

A combustion type power tool according to an embodiment of the present invention will be described in detail, with reference to FIGS. 1 through 6. The embodiment pertains to a nail gun. In these drawings, like parts and components are designated by the same reference numerals. Similarly, the components identical in function to those of the conventional combustion type power tool shown in FIGS. 7 to 13 are designated at the same reference numbers. Further, the direction in which nails (fasteners) are driven will be referred to as “lower” or “lower portion”, and the direction opposite to this direction will be referred to as “upper” or “upper portion”, for the sake of convenience. Nonetheless, these words and terms are not limited to specific meanings.

1. Overall Configuration of Nail Gun

As shown in FIG. 1, the nail gun 1 includes a housing 7 having a main housing section 7a. The main housing section 7a accommodates therein a cylinder 2 (described later). A handle 7c serving as a grip of the nail gun 1 is provided on a side of the housing 7. A trigger switch 13 is secured to the handle 7c. The main housing section 7a and the handle 7c define a canister housing 7b for accommodating or setting a gas canister 22, i.e., a fuel cell. The nail gun 1 has a magazine 27 secured to the lower end of the handle 7c for holding nails (fasteners).

The main housing section 7a contains the cylinder 2, a chamber head 5 formed with an injection port 23, an ignition plug 26, a fan motor 20, a fan 21, a combustion chamber frame 4, a piston 3, a driver blade 16, and a bumper 29. The cylinder 2 extends in a longitudinal direction of the housing 7. The chamber head 5 is fixed to the housing 7 for covering an upper space of the cylinder 2. The injection port 23 is formed in the chamber head 5 in order to supply combustible gas. The ignition plug 26 is secured to the chamber head 5. The fan motor 20 and the fan 21 are supported by the chamber head 5. The combustion chamber frame 4 is vertically movable within the housing 7 while sliding on an outer peripheral surface of the cylinder 2. The combustion chamber frame 4 is seatable on an upper peripheral end portion 2a of the cylinder 2 and an peripheral abutting part 5a of the chamber head 5 when the combustion chamber frame 4 is moved to its top dead center.

The piston 3 is slidably reciprocally movable with respect to the cylinder 2 between the upper end and lower end of the cylinder 2. The driver blade 16 is secured to the lower surface of the piston 3 for striking a nail 15, as the piston 3 moves downwards toward the lower end of the cylinder 2. The bumper 29 is adapted fro absorbing an excessive impact force that is generated when the piston 3 is moved toward the lower end of the cylinder 2.

The chamber head 5 is secured at the upper end of the main housing section 7a. The fan motor 20 is supported on the chamber head 5. A motor shaft extends through the chamber head 5, so that the fan 21 is secured to the motor shaft. The chamber head 5 is adapted for holding the ignition plug 26 which generates a spark when the trigger switch 13 on the handle 7c is operated. A push switch (not shown) is provided in the main housing section 7a. The push switch is adapted for detecting a predetermined position of a coupling member (not shown) connected to the combustion chamber frame 4, in order to determine whether the combustion chamber frame 4 lies a position near its upper dead center when the entire nail gun 1 is pushed to a workpiece W. When the combustion chamber frame 4 rises to the predetermined position, the push switch is turned on, supplying a drive voltage to the motor 20. Thus, the motor 20 starts rotating the fan 21.

A battery 28 such as a nickel-cadmium secondary battery is detachably set in the handle 7c. The battery 28 serves as a power source of the nail gun 1. An ignition control device (not shown) is also set in the handle 7c. The ignition control device controls ON/OFF of the fan motor 21 and control spark generation of the ignition plug 26.

The canister housing section 7b includes a canister-housing partition wall that surrounds the gas canister 22 so that the gas canister 22, i.e., fuel cell, is detachably set in the partition wall. The canister-housing partition wall defines a canister housing 25. A nozzle receptacle is formed in a part of the chamber head 5 and at a position at an upper portion of the canister housing section 7b. The nozzle receptacle is adapted to receive an injection nozzle 22a of the gas canister 22.

The gas canister 22 contains pressurized liquefied combustible gas. The gas evaporates when the gas is released into the atmosphere. At the upper end portion of the gas canister 22, a valve mechanism 22b is provided for adjusting a flow rate of the gas to be supplied from the injection nozzle 22a. A pushing mechanism (not shown) is provided for pushing one side surface of the gas canister 22, the one side being opposite to the injection nozzle 22a, while the gas canister 22 remains set in the nozzle receptacle, in order to inject a prescribed amount of the combustible gas into the injection port 23 of the chamber head 5. The combustible gas is injected into the injection port 23 when a combustion chamber 6 (described later) is defined as a result of movement of the combustion chamber frame 4.

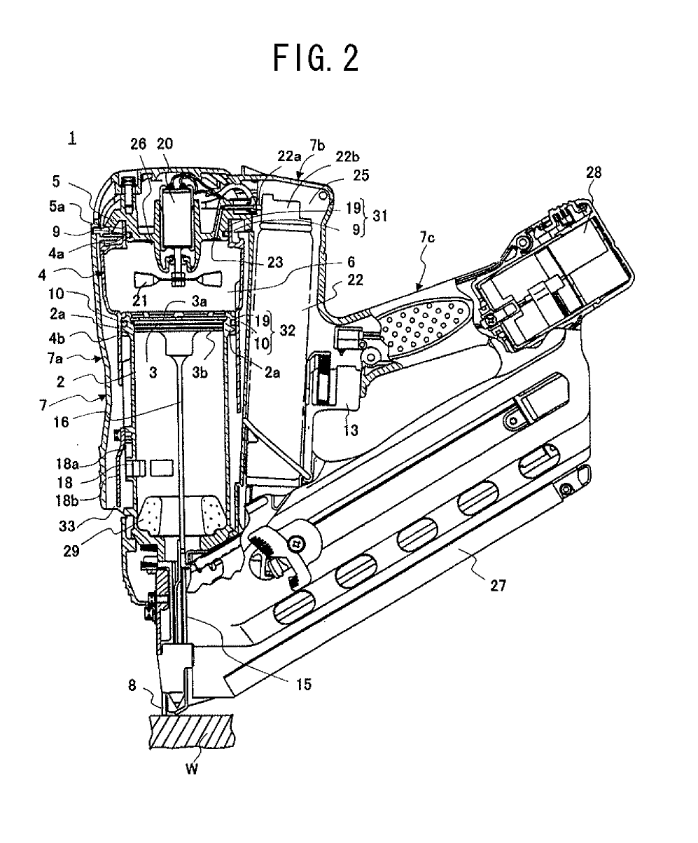

A nose section 30 integrally extends downward from the lower end portion of the cylinder 2 for allowing each nail 15 to pass through the nose section 30. A push lever 8 (contact lever) is disposed immediately below the main housing section 7a. The push lever 8 is movable along an outer peripheral surface of the nose section 30. The push lever 8 is coupled, through the coupling member (not shown), to the combustion chamber frame 4. A compression coil spring (not shown) is provided for biasing the push lever 8 and the coupling member downwards, i.e., in a direction away from the chamber head 5. Hence, when a user pushes the housing 7 toward the workpiece W, while the distal end of the push lever 8 abutting on the workpiece W, the upper end of the push lever 8 moves upward in the main housing section 7a as shown in FIG. 2, against the biasing force of the compression coil spring (not shown).

Thus, the push lever 8 pushes the combustion chamber frame 4 upward toward the upper end portion 2a of the cylinder 2 and toward the chamber head 5. The combustion chamber frame 4 eventually seats on the peripheral abutting part 5a of the chamber head 5 and also contacts with the upper end portion 2a of the cylinder 2. Therefore, the chamber head 5, the combustion chamber frame 4, and an upper surface 3a of the piston 3 define a combustion chamber 6 as shown in FIG. 2.

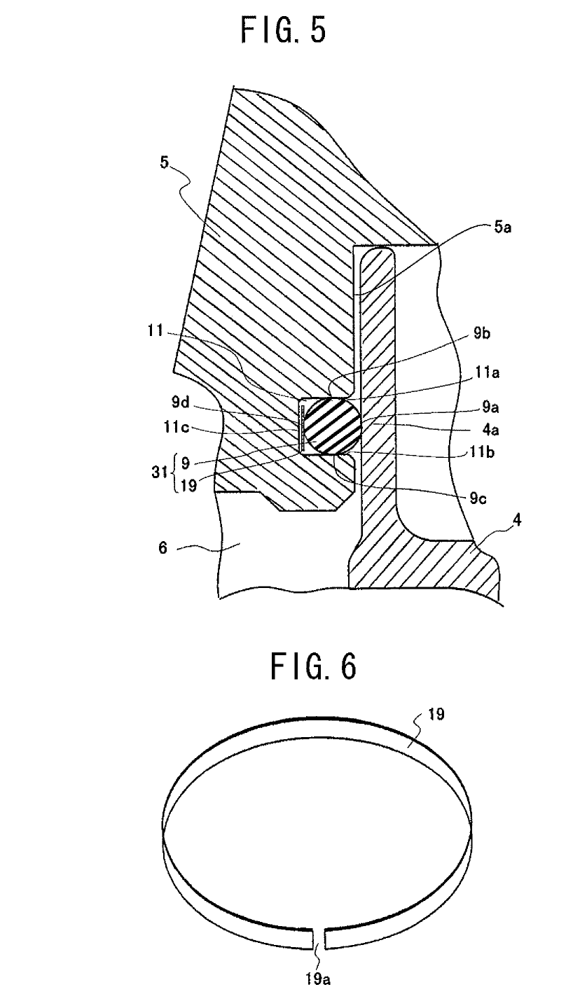

As shown in FIG. 5, a first seal unit 31 is assembled on the chamber head 5. The first seal unit 31 includes an endless O-ring 9 and a back-up ring 19 having a gap 19a. The back-up ring 19 is positioned in contact with a radially inner peripheral surface of the O-ring 9 so as to expand the O-ring 9 radially outwardly. The O-ring 9 and the back-up ring 19 are adapted for sealing a gap between the peripheral abutting part 5a of the chamber head 5 and an upper end seal part 4a of the combustion chamber frame 4 when the upper end seal part 4a abuts on the peripheral abutting part 5a.

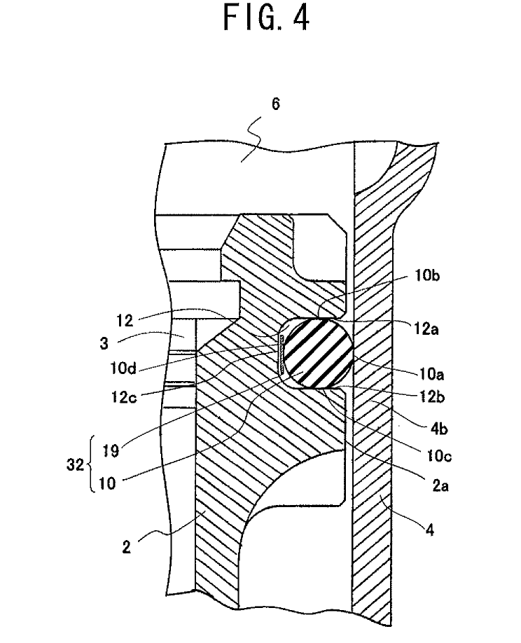

As shown in FIG. 4, a second seal unit 32 is assembled on the peripheral abutting part 2a provided at the upper end portion of the cylinder 2. The second seal unit 32 includes an endless O-ring 10 and a back-up ring 19 having a gap 19a. The back-up ring 19 is positioned in contact with a radially inner peripheral surface of the O-ring 9 so as to expand the O-ring 9 radially outwardly. The O-ring 10 and the back-up ring 19 are adapted for sealing a gap between a lower end seal part 4b of the combustion chamber frame 4 and the peripheral abutting part 2a of the cylinder 2 when the combustion chamber frame 4 abuts on the chamber head 5.

When the upper end seal part 4a of the combustion chamber frame 4 is pushed up by the push lever 8, the upper-end seal part 4a abuts on the peripheral abutting part 5a of the chamber head 5, defining the combustion chamber 6. More specifically, as shown in FIG. 2, the chamber head 5, the combustion chamber frame 4, the space in the cylinder 2 above the piston 3, the first O-ring 9, and the second O-ring 10 define a sealed combustion chamber 6 when the upper end seal part 4a of the combustion chamber frame 4 abuts on the peripheral abutting part 5a of the chamber head 5.

Almost at the same time, the pushing mechanism pushes the gas canister 22. As a result, the combustible gas is injected from the injection nozzle 22a of the gas canister 22 into the combustion chamber 6.

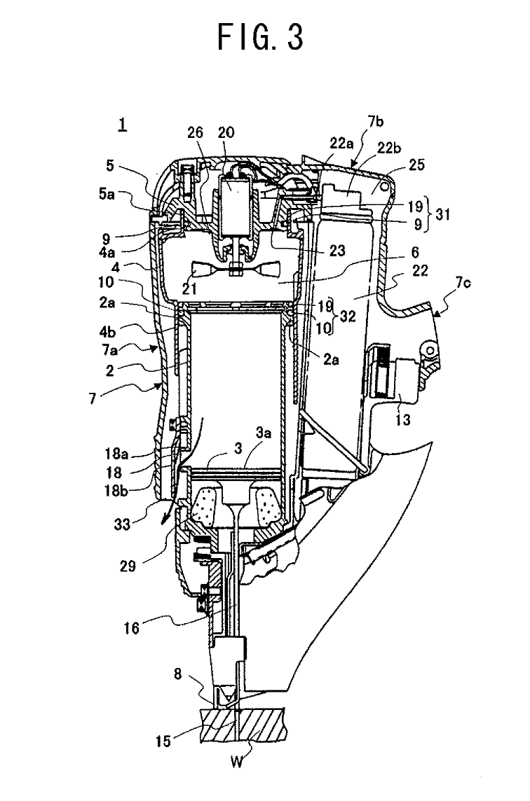

The cylinder 2 has a lower end portion formed with a gas vent hole 18. The gas vent hole 18 communicates with an exhaust opening 33 formed in the main housing section 7a. In the gas vent hole 18, an exhaust gas check valve 18a is provided to guide exhaust gas from the inner circumferential surface of the cylinder 2 to the outer circumferential surface thereof. An exhaust cover 18b is provided covering the gas vent hole 18. The exhaust cover 18b guides a part of the combusted gas exhausted through the gas vent hole 18 along the axial direction of the cylinder 2, thus changing the direction of the exhaust-gas flow. Until a predetermined time elapses after the gas is combusted, the combustion chamber frame 4 remains in abutment with the chamber head 5 as shown in FIG. 3. The combusted gas is exhausted through the exhaust gas check valve 18a and the exhaust opening 33.

When the pressure in the combustion chamber 6 is reduced to an atmospheric pressure, the exhaust gas check valve 18a is closed, sealing the combustion chamber 6 and a space within the cylinder 2 and above the upper surface 3a of the piston 3. Thereafter, the temperature in the combustion chamber 6 is lowered as the cylinder 2 radiates heat. Accordingly, negative pressure is generated in the combustion chamber 6 and the space in the cylinder 2 and above the piston (so-called “thermal vacuum” is generated). As a result, the piston 3 is moved upward, returning to the top dead center shown in FIG. 2, due to the pressure difference between the space above the upper surface 3a of the piston 3 and the space below the lower surface 3b of the piston 3 since the lower surface 3b side is at the atmosphere pressure.

The driver blade 16 extends from the lower surface 3b of the piston 3 toward the nose 30. The driver blade 16 is coaxial with the nail 15 set in the nose 30 (FIG. 1) for striking against the nail 15. The piston 3 moves down and stops when the piston 3 abuts on the above-described bumper 29.

The fan 21 is disposed in the combustion chamber 6, and the ignition plug 26 is supported in the chamber head 5 and is oriented to open to the combustion chamber 6. As long as the combustion chamber frame 4 contacts the chamber head 5, the fan 21 performs three functions. First, the fan 21 stirs the combustible gas and mixes the gas with air, generating mixture gas. Second, the fan 21 causes turbulent combustion, thus promoting the combustion after the gas mixture is ignited. Third, the fan 21 performs scavenging by expelling the combusted gas from the combustion chamber 6 and introducing a fresh air, and cools the combustion chamber frame 4 and the cylinder 2 when the combustion chamber frame 4 leaves the chamber head 5 thus forming an exhaust passage (not shown).

2. Structures of Seal Units 31 and 32

According to this invention, the first seal unit 31 and the second seal unit 32 are provided on the upper-end seal part 4a and lower-end seal part 4b of the combustion chamber frame 4, respectively. These seal units will be described in detail.

The seal unit 32 will be described with reference to FIGS. 4 and 5. The seal unit 32 is assembled on the lower-end seal part 4b of the combustion chamber frame 4. More specifically, the peripheral abutting part 2a of the cylinder 2 is formed with an annular groove 12 extending in a circumferential direction thereof. The O-ring 10 is made from an elastic material such as a rubber, and is an endless ring designed to achieve airtight sealing. Further, the O-ring 10 has a circular cross-section.

The O-ring 10 is fitted in the annular groove 12. The back-up ring 19 is also fitted in the groove 12. The back-up ring 19 lies at an inner periphery 10d of the O-ring 10 and urges the O-ring 10 radially outwards. The back-up ring 19 is constituted by a C-ring formed with a gap or lip portion and is made by circularly bending a metal strip such as a steel strip. The back-up ring 19 is inserted between the inner periphery 10d of the O-ring 10 and a bottom 12c of the groove 12. The outer periphery part 10a of the O-ring 10 is biased radially outwards by the radially outward expansion force of the back-up ring 19, so that the entire outer peripheral surface 10a of the O-ring 10 is in intimate contact with the inner peripheral surface of the lower end seal portion 4b of the combustion chamber frame 4. Thus, no gap is provided therebetween. Suitable biasing force that the back-up ring 19 exerts on the O-ring 10 can be provided by selecting a material of the back-up ring 19 and/or by changing a thickness and radial width thereof and the shape thereof.

In the above-described embodiment, the back-up ring 19 biases the inner periphery of the O-ring 10 radially outwardly at all times. Therefore, the combustion chamber 6 can remain air-tightness even if the O-ring 10 is thermally deformed. This is a desirable, because air-tightness of the combustion chamber 6 can be maintained regardless of overheating in the combustion chamber due to repeated fastener driving operation.

As shown in FIG. 5, the other seal unit 31 on the upper end seal part 4a of the combustion chamber frame 4 is totally identical to the above-described seal unit 32. That is, an annular groove 11 is formed in the peripheral abutting part 5a of the chamber head 5. The O-ring 9 is fitted in the annular groove 11. A back-up ring 19 is also fitted in the groove 11. The back-up ring 19 lies at the inner periphery 9d of the O-ring 9 and pushes the O-ring 9 radially outwardly. The back-up ring 19 is constituted by the above described C-ring. The back-up ring 19 is inserted between the inner periphery 9d of the O-ring 9 and the bottom 11c of the groove 11. The outer periphery part 9a of the O-ring 9 is biased radially outwardly so that the entire peripheral surface thereof is in intimate contact with the inner peripheral surface of the upper end seal part 4a of the combustion chamber frame 4. Thus, no gap is formed therebetween. The O-ring 9 is made from an elastic material such as a rubber, and is an endless ring designed to achieve airtight sealing. Further, the O-ring 9 has a circular cross-section.

In the seal units 31 and 32, the O-rings 9 and 10 are radially outwardly biased by the back-up rings 19, 19. Therefore, the outer peripheral surfaces of the O-rings 9 and 10 are positioned slightly radially outwardly of the peripheral abutting part 5a of the chamber head 5 and the upper peripheral end portion 2a of the cylinder 2. Therefore, the size and cross-sectional shape of the O-rings 9, 10, dimension of the annular grooves 11, 12, biasing force of the back-up rings 19, 19 and a cross-sectional shape of the top end of the combustion chamber frame 4 should be carefully designed, so that the slightly protruding O-ring 9 can ride and move over the peripheral abutting part 5a, and so that the inner surfaces of the combustion chamber frame 4 can ride and move over the slightly protruding outer periphery of the O-rings 10, otherwise the top end of the combustion chamber frame 4 may be abutted against the slightly protruding O-ring 9 which may serve as an obstacle for the upward movement of the combustion chamber frame 4. In the sliding state, the O-rings 9 and 10 are biased radially inwardly by the peripheral abutting part 5a of the chamber head 5 and the upper peripheral end portion 2a of the cylinder 2 against the biasing forces of the back-up rings 19, 19.

3. Operation of Nail Gun 1

For starting fastener driving operation, the user holds the handle 7c and press the push lever 8 to the workpiece W, so that the tool 1 assumes such a state as shown in FIG. 2, and the combustion chamber frame 4 moves upward. When the combustion chamber frame 4 reaches a predetermined position, the frame 4 defines, along with the first seal unit 31 and the second seal unit 32, the combustion chamber 6 sealed from the atmosphere. As the combustion chamber frame 4 further moves upwards, the pushing mechanism (not shown) operated in interlocking relation with the movement of the combustion chamber frame 4 pushes the gas canister 22 toward the chamber head 5. The combustible gas is thereby injected once with a prescribed amount from the injection nozzle 22a. The combustible gas is supplied through the gas injection port 23 into the combustion chamber 6 that remains closed. The combustion chamber 6 is therefore filled with the combustible gas that will cause an explosion.

When the combustion chamber frame 4 further moves to a position near its top dead center as the push lever 8 moves, the push switch (not shown) is turned on. As a result, the fan 21 starts rotating in the sealed combustion chamber 6. The fan 21 stirs and mixes the combustible gas and air, forming gas mixture in the combustion chamber 6.

When the combustion chamber frame 4 reaches the top dead center, and the trigger switch 13 of the handle 7c is pulled, a spark circuit of the ignition control device (not shown) is turned ON to generate a spark from the ignition plug 26, igniting the gas mixture. At this time, the fan 21 keeps rotating, promoting the turbulent combustion of the gas mixture. This increases the output of the nail gun 1. The gas expands as the gas is combusted, pushing the piston 3 downwards. Until the piston 3 abuts on the bumper 29, the driver blade 16 drives into the workpiece W the nail 15 supplied from the magazine 27 to the nose section 30.

As shown in FIG. 3, as the piston 3 moves down, reaching a position below the gas vent hole 18 of the cylinder 2, the pressure of the combusted gas pushes the exhaust gas check valve 18a. The gas vent hole 18 is thereby opened. The combusted gas is released outside the cylinder 2 and discharged outside through the exhaust opening 33 of the main housing section 7a. When the combusted gas is released outside the cylinder 2 and the pressure in the cylinder 2 and combustion chamber 6 changes to the atmospheric pressure, the exhaust gas check valve 18a is closed. The combusted gas remaining in the cylinder 2 and combustion chamber 6 is at a high temperature immediately after the combustion. However, the combusted gas is rapidly cooled as the heat thereof is absorbed into the inner circumferential surface of the cylinder 2 and the inner circumferential surface of the combustion chamber frame 4. The air pressure in the closed space above the upper surface 3a of the piston 3 falls to a value equal to or lower than the atmospheric pressure. That is, because of a so-called thermal vacuum, the pressure in that part of the combustion chamber 6 which lies above the piston 3 becomes equal to or lower than the atmospheric pressure. The pressure in that part of the cylinder 2 which lies below the lower surface 3b of the piston 3 and near the driver blade 16 becomes higher than the pressure in that part of the cylinder 2 which lies near the combustion chamber 6. The piston 3 is therefore pushed back to the initial position, i.e., the top dead center, as is illustrated in FIG. 2.

When the user lifts the nail gun 1 from the workpiece W thus leaving the push lever 8 from the workpiece W and then turns off the trigger switch 13 as shown in FIG. 1, the push lever 8 and the combustion chamber frame 4 return to their lower positions by virtue of the biasing force of the compression coil spring (not shown). As the combustion chamber frame 4 moves down, the combustion chamber 6 is brought into communication with the atmosphere. As a result, the residual combusted gas is expelled from the combustion chamber 6 and fresh air flows into the combustion chamber 6, i.e., scavenging is performed. Thus, the tool 1 can restore original position for the next driving operation.

4. Sealing Effect Achieved by Seal Units 31 and 32

In the nail gun 1 described above, the combustible gas is combusted in the combustion chamber 6 when the ignition plug 26 generates a spark. Then, the combustion pressure is applied to the upper surface 3a of the piston 3. The piston 3 moves down at once, driving the nail 15 located below the driver blade 16. At this time, the combustion pressure at the seal unit 32 shown in FIG. 4 is about 6 kgf/cm². In the second seal unit 32, at the lower end seal part 4b of the combustion chamber frame 4, the lower part 10c of the O-ring 10 contacts the lower side 12b of the annular groove 12 formed in the cylinder 2. At the same time, the lower end seal part 4b contacts the outer peripheral part 10a of the O-ring 10. Thus, sealing is accomplished at two parts 10c and 10a of the O-ring 10. In this case, perfect sealing is achieved since the combustion pressure is as high as 6 kgf/cm² and a sufficient pressure is applied to the O-ring 10. Therefore, the combusted gas never leaks outside from the combustion chamber 6.

Similarly, sealing by the first seal unit 31 is accomplished at two parts of the O-ring 9 provided at the upper end seal part 4a of the combustion chamber frame 4 as shown in FIG. 5. That is, the upper part 9b of the O-ring 9 contacts the upper side 11a of the annular groove 11 of the chamber head 5, and the upper-end seal part 4a contacts the outer peripheral part 9a of the O-ring 9 at the same time.

Because of the sealing achieved by the first and second seal units 31 and 32, the combusted gas at high pressure generated at the time of combustion does not leak outside from the combustion chamber 6. Hence, the piston 3 can make use of the combustion pressure as much as possible as energy for driving the nail.

As the piston 3 moves down, reaching a position below the gas vent hole 18, part of the combusted gas is discharged to the atmosphere through the exhaust gas check valve 18a. Then, the pressure in the combustion chamber 6 becomes lower than the atmospheric pressure when the combustion is completed because of the above described thermal vacuum. The piston 3 therefore starts returning to the top dead center. While the piston 3 is returning to the top dead center, the pressure in the combustion chamber 6 is about 0.8 kgf/cm². The pressure difference of 0.2 kgf/cm² between the outside pressure of 1 kgf/cm² and the pressure of 0.8 kgf/cm² in the combustion chamber 6 must be utilized as much as possible without a loss, to push up the piston 3 to the initial position (i.e., top dead center). In the present embodiment, the O-ring 10 abutting on the lower end seal part 4b of the combustion chamber frame 4 accomplishes perfect sealing at two points as shown in FIG. 4. Namely, as the piston 3 returns to the initial position, the upper part 10b of the O-ring 10 contacts the upper side 12a of the annular groove 12, and at the same time, the outer peripheral part 10a of the O-ring 10 contacts the lower end seal part 4b of the combustion chamber frame 4 because the outer periphery part 10a is pressed by the back-up ring 19 provided on the inner periphery 10d of the O-ring 10.

Similarly, in the first seal unit 31, the lower side 11b of the annular groove 11 formed in the chamber head 5 and the lower part 9c of the O-ring 9 are sealed together, and the upper end seal part 4a and the outer peripheral part 9a of the O-ring 9 are sealed together at the same time.

Thus, the pressure difference of 0.2 kgf/cm² can be maintained during the return stroke of the piston 3 since no accidental gap is formed at the sealing regions. Since no external air flows into the combustion chamber 6 through the accidential gap, a return of the piston 3 to the initial position (top dead center) can be ensured.

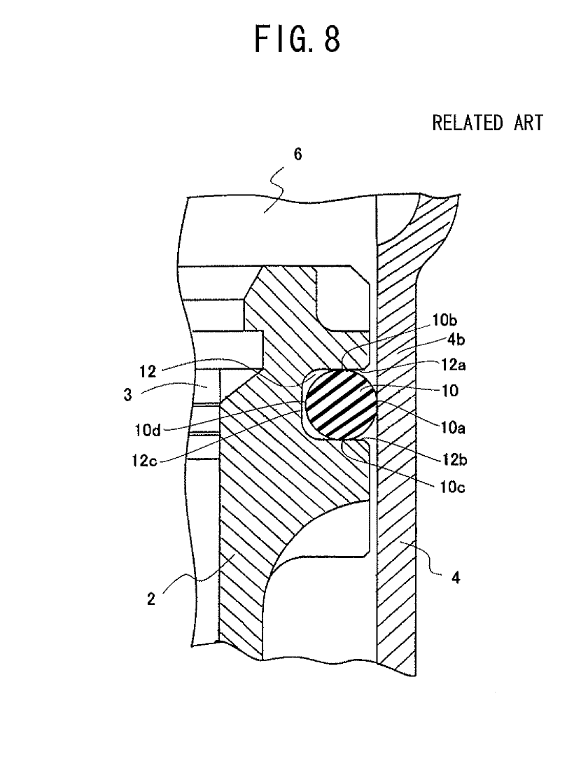

For the purpose of comparison, comparative sealing arrangements will be described with reference to FIGS. 8 through 13. FIG. 8 through 10 illustrates a seal unit in accordance with a related art and to be provided between a cylinder and a combustion chamber frame in the conventional combustion type power tool shown in FIG. 7. The seal unit includes solely an endless O-ring made of a rubber.

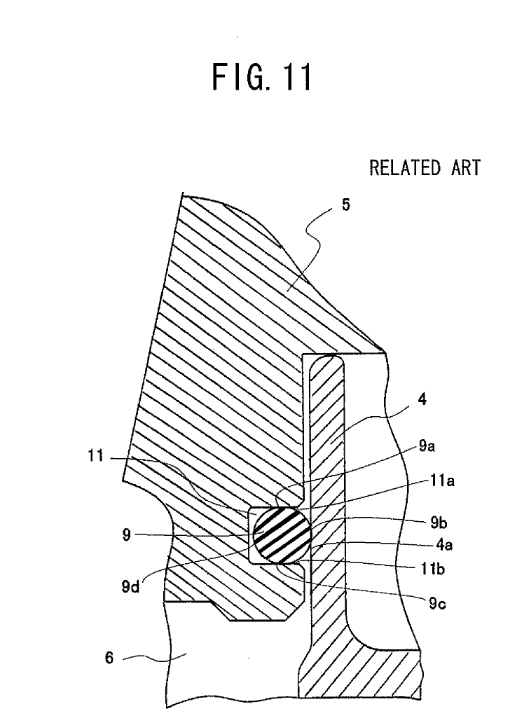

### Further, FIG. 11 illustrates another seal unit in accordance with the related art and to be provided between a chamber head and the combustion chamber frame.

The pressure in the combustion chamber is about 6 kgf/cm² at the time of combustion. In this case, as shown in FIG. 8, the combustion pressure pushes down the O-ring 10 made of rubber. As a result, the lower part 10c of the O-ring 10 is pressed onto the lower side 12b of the groove 12 formed in the cylinder 2. At the same time, the outer peripheral part 10a of the O-ring 10 contacts the lower end seal part 4b of the combustion chamber frame 4. At this point, the combustion pressure is so high that the combusted gas pushes the O-ring 10. This provides a sufficient sealing effect, and the combusted gas will not leak at the sealing part of the combustion chamber 6 similar to the above-described embodiment.

At the completion of combustion, the seal between the outer peripheral part 10a of the O-ring 10 and the lower end seal part 4b of the combustion chamber frame 4 and the other seal between the upper part 10b of the O-ring 10 and the upper side 12a of the annular groove 12 should be reliable. However, these seals are incomplete.

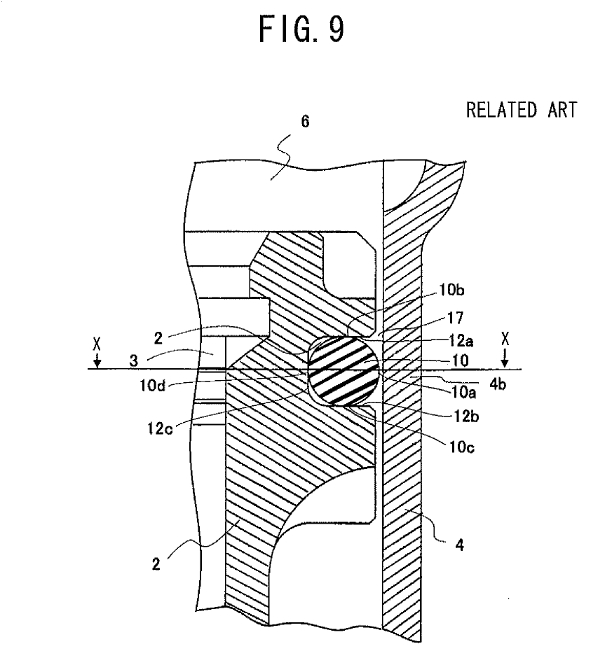

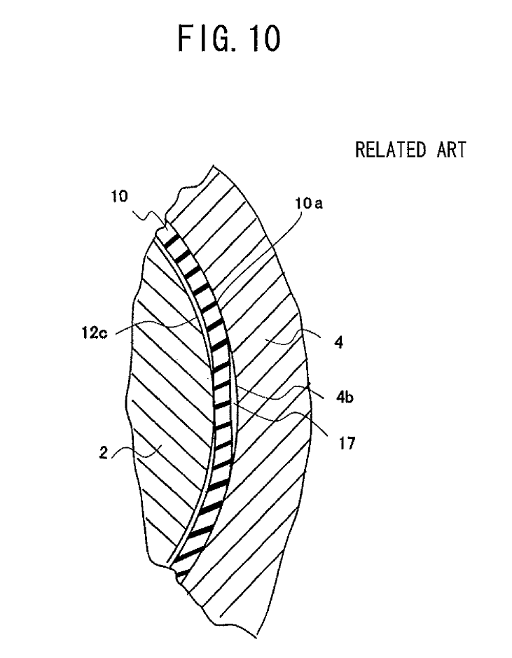

As shown in FIGS. 9 and 10, a gap 17 develops at the seal between the outer peripheral part 10a of the O-ring 10 and the lower end seal part 4b of the combustion chamber frame 4. Consequently, external air flows into the combustion chamber 6 through the gap 17. Therefore, a pressure difference (0.2 kgf/cm²) large enough to push the piston 3 back to the initial position (top dead center) cannot be obtained at all.

The present inventors found the following disadvantages in the related art. When the sealing effect of the O-ring 10 or 9 is insufficient and an incomplete seal 17 therefore develops, the external air will flow into the combustion chamber 6 upon completion of combustion. The pressure in the combustion chamber 6 can no longer remain lower than the atmospheric pressure. Since the piston 3 cannot return to the uppermost position (i.e., top dead center), the output of the power tool decreases in the subsequent operation. Thus, the power tool cannot apply a sufficient impact to the head of a fastener such as a nail. In some cases, the driver blade 16 secured to the lower surface 3b of the piston 3 may fail to return to the initial position that lies above the head of the nail. Then, the driver blade restricts the motion of the nails in the magazine, and the nails may not be driven into workpieces.

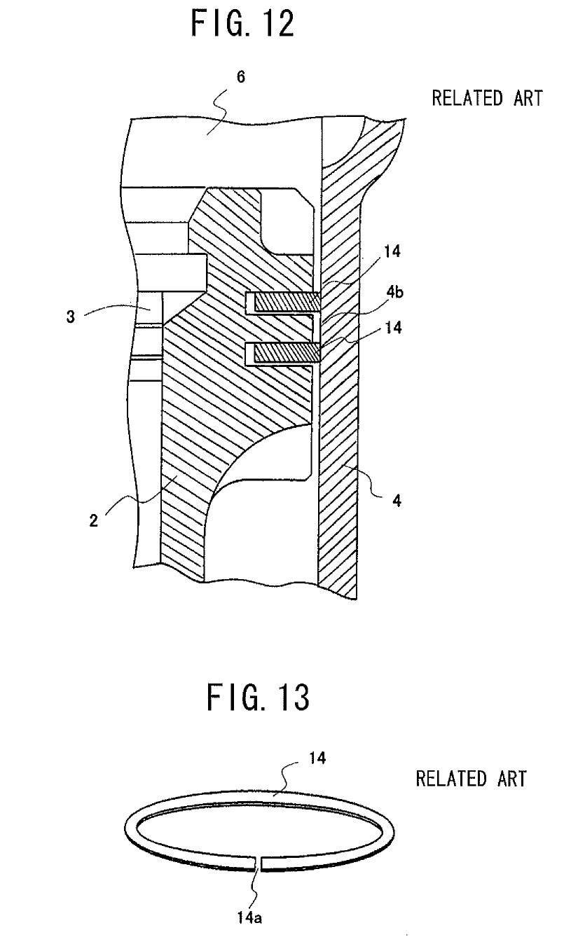

FIGS. 12 and 13 show still another sealing arrangement including a plurality of C-rings provided between a cylinder and a combustion chamber frame in accordance with a related art in an attempt to enhance sealability. These C-rings are generally expensive since these are made from iron material. Further, much labor and cost is required to form a plurality of annular grooves. Moreover, C-rings made of iron have a slit 14a to generate a tension. However, the slit provides a gap or a passage to allow fluid to pass therethrough, which is disadvantageous to provide a pressure difference for returning the piston to the initial position.

While the invention has been described in detail with reference to the specific embodiment thereof, it would be apparent to those skilled in the art that various changes and modifications may be made therein without departing from the scope of the invention.

What is claimed is:

1. A combustion type power tool comprising:
a housing having one end and another end;
a chamber head fixed to the one end of the housing;
a cylinder fixedly disposed in the housing;
a combustion chamber frame movable toward and away from the chamber head within the housing, a combustion chamber being defined when the combustion chamber frame is in abutment with the chamber head, at least one of the chamber head and the cylinder being formed with an annular groove; and,
at least one sealing unit assembled in the annular groove and comprising a sealing member, and a back-up ring disposed in contact with the sealing member, the back-up ring providing a radially outward expansion force for urging the sealing member radially outwardly.

2. The combustion type power tool as claimed in claim 1, wherein the sealing member is an O-ring.

3. The combustion type power tool as claimed in claim 2, wherein the O-ring is made from a rubber, and wherein the back-up ring has a C-shape configuration forming a slit extending in a radial direction thereof.

4. The combustion type power tool as claimed in claim 3, wherein the O-ring has a circular cross-section.

5. The combustion type power tool as claimed in claim 3, wherein the back-up ring is made from a metal.

6. The combustion type power tool as claimed in claim 5, wherein the back-up ring is made from steel.

7. the combustion type power tool as claimed in claim 1, wherein the chamber head has an outer peripheral part serving as a first region; and
wherein the cylinder has an outer peripheral part serving as a second region; and
wherein the combustion chamber frame has a third region to be faced with the first region and a fourth region to be faced with the second region, the annular groove being formed at least one of the first region and the second region.

8. The combustion type power tool as claimed in claim 7, wherein the first region is formed with a first annular groove, and the second region is formed with a second annular groove; and
wherein the sealing unit comprises a first sealing unit assembled in the first annular groove, and a second sealing unit assembled in the second annular groove.

9. The combustion type power tool as claimed in claim 1, further comprises:
a piston reciprocally slidably movably disposed in the cylinder;
a driver blade extending from the piston and at a position opposite to the chamber head with respect to the piston;
a push lever movably disposed at a side of the another end of the housing, the push lever having a tip end to be in contact with a workpiece, the combustion chamber frame being movable in interlocking relation to the movement of the push lever; and
an ignition plug exposed to the combustion chamber for igniting a combustible gas introduced into the combustion chamber.
